(19) United States
(12) Patent Application Publication
(10) Pub. No.: US 2026/0027650 A1
(43) Pub. Date: Jan. 29, 2026

(54) SYSTEM AND METHODS FOR TRANSPORTING CONFECTIONARY PRODUCTS

(71) Applicant: Mars, Incorporated, McLean, VA (US)

(72) Inventors: Richard AMMENDOLA, Naperville, IL (US); Peter KASHULINES, McLean, VA (US); Frank MESHACH, McLean, VA (US)

(21) Appl. No.: 18/781,395

(22) Filed: Jul. 23, 2024

(51) Int. Cl. B23K 26/08; A23G 3/02; A23G 3/34; B23K 26/06; B23K 26/362; B23K 26/402; B65G 17/06; B65G 17/46; B65G 47/76

(52) U.S. Cl. CPC B23K 26/0838; A23G 3/0004; A23G 3/02; B23K 26/06; B23K 26/362; B23K 26/402; B65G 17/065; B65G 17/46; B65G 47/763; B65G 2201/0202; B65G 2203/0283

(57) ABSTRACT

A system may include a conveyor system that rotates about a first axis in a transporting direction and has a transport path that transports objects from a first end to a second end. A system may include one or more carrier bars, each carrier bar including a timing sensor, attached to the conveyor system that have a plurality of cavities, each cavity including a thru-hole, such that an object is able to at least partially fit within one cavity of the plurality of cavities. A system may include a laser system configured to interact with the objects while the objects are within the cavities on the transport path between the first end and the second end and the laser system produces a plurality of beam segments that are calibrated by the timing sensors and configured to laser-etch an outer surface of an object.

### TECHNICAL FIELD

This disclosure generally relates transporting confectionary products.

### BACKGROUND

Products are often transported via conveyor systems during production. In some applications, such as confectionary products, there are many small pieces of product that need to be transported for manufacturing, processing, production, etc. at a high rate. Some systems are incompatible with the disorganized product supplied and/or struggle to keep up with the rate of product supplied. For example, laser-etching systems uses laser energy to target, ablate, and remove at least part of a substrate included in a given confectionary product. Because of this, the product needs to be provided to the laser-etching system in a way that the system can properly ablate the outer surfaces of the product. The conveyor system must provide the product in such a way that the laser system can etch quickly enough. Transporting the product inefficiently can dramatically reduce the production rate of a laser-etching system or any production system. Accordingly, there is an ongoing need for a system or method of conveying product in a timely manner for laser-etching systems or otherwise.

### SUMMARY

In some aspects, the techniques described herein relate to a system for transporting a plurality of objects, the system including: a conveyor system with a transport path that transports the plurality of objects from a first end to a second end, the conveyor system rotating about a first axis in a transporting direction; one or more carrier bars attached to the conveyor system, the one or more carrier bars having a plurality of cavities such that one object of the plurality of objects is able to at least partially fit within one cavity of the plurality of cavities, wherein each cavity of the plurality of cavities include a thru-hole, and wherein each carrier bar of the one or more carrier bars include a timing sensor; and a laser system configured to interact with the plurality of objects while the plurality of objects are within the plurality of cavities on the transport path between the first end and the second end, wherein the laser system produces a plurality of beam segments, wherein each beam segment is configured to laser-etch an outer surface of an object of the plurality of objects, and wherein the timing sensor calibrates the plurality of beam segments.

In some aspects, the techniques described herein relate to a system, the system further including: a moving apparatus configured to move any one of the plurality of objects outside of one of the plurality of cavities and/or on top of another one of the plurality of objects inside one of the plurality of cavities on the transport path such that only objects within the plurality of cavities are transported to the laser system.

In some aspects, the techniques described herein relate to a system, the system further including: a user interface configured to allow a user of the system to at least turn the laser system on, turn the laser system off, turn the conveyor system on, turn the conveyor system off, release the one or more carrier bars, and/or move the moving apparatus closer to or farther from the transport path and/or between the first end and the second end.

In some aspects, the techniques described herein relate to a system, the system further including: a laser absorption plate, wherein the plurality of beam segments are directed through the thru-holes onto the laser absorption plate for any of the plurality of cavities that are empty.

In some aspects, the techniques described herein relate to a system, wherein, for each carrier bar of the one or more carrier bars, the timing sensor is a cutout closer to a first end of the carrier bar than a second end of the carrier bar.

In some aspects, the techniques described herein relate to a system, wherein a first side and a second side of the carrier bar between the first end and the second end are shaped by at least a portion of a perimeter of the plurality of cavities.

In some aspects, the techniques described herein relate to a system, wherein the one or more carrier bars are connected to the conveyor system via a pin connection.

In some aspects, the techniques described herein relate to a method for transporting a plurality of objects, the method including: attaching one or more carrier bars to a conveyor system, the one or more carrier bars having a plurality of cavities such that one object of the plurality of objects is able to at least partially fit within one cavity of the plurality of cavities, wherein each cavity of the plurality of cavities include a thru-hole; positioning the plurality of objects into the plurality of cavities via a moving apparatus such that any one of the plurality of objects outside of one of the plurality of cavities and/or on top of another one of the plurality of objects inside one of the plurality of cavities is moved into an empty cavity of the plurality of cavities; and transporting the plurality of objects from a first end to a second end of a transport path of a conveyor system, the conveyor system rotating about a first axis in a transporting direction, wherein the moving apparatus is positioned closer to the first end than the second end of the transport path.

In some aspects, the techniques described herein relate to a method, wherein the moving apparatus is a brush or a roller.

In some aspects, the techniques described herein relate to a method, the method further including: laser-etching the plurality of objects via a laser system between the first end and second end of the transport path, wherein the laser system produces a plurality of beam segments, and wherein each beam segment of the plurality of beam segments is directed onto an outer surface of an object of the plurality of objects such that each beam segment laser-etches the outer surface of the object.

In some aspects, the techniques described herein relate to a method, wherein each cavity of the plurality of cavities include a timing sensor to calibrate the plurality of beam segments.

In some aspects, the techniques described herein relate to a method, the method further including: controlling, via a user interface, the conveyor system, wherein controlling the conveyor system includes at least one of turning the conveyor system on, turning the conveyor system off, or releasing the one or more carrier bars.

In some aspects, the techniques described herein relate to a method, wherein the plurality of beam segments are directed through the thru-holes onto a laser absorption plate for any of the plurality of cavities that are empty.

In some aspects, the techniques described herein relate to a system for transporting a plurality of objects, the system including: a conveyor system with a transport path that transports the plurality of objects from a first end to a second end, the conveyor system rotating about a first axis in a transporting direction; one or more carrier bars attached to the conveyor system, the one or more carrier bars having a plurality of cavities such that one object of the plurality of objects is able to at least partially fit within one cavity of the plurality of cavities; and a user interface configured to allow a user of the system to at least turn the conveyor system on, turn the conveyor system off and/or release the one or more carrier bars.

In some aspects, the techniques described herein relate to a system, the system further including: an inlet adjacent to the first end, the inlet grouping the plurality of objects for transportation on the conveyor system via the transport path.

In some aspects, the techniques described herein relate to a system, wherein the plurality of cavities are substantially circular.

In some aspects, the techniques described herein relate to a system, wherein the plurality of cavities are equally spaced apart.

In some aspects, the techniques described herein relate to a system, the system further including: a roller configured to move any one of the plurality of objects outside of one of the plurality of cavities and/or on top of another one of the plurality of objects inside one of the plurality of cavities on the transport path such that only objects within the plurality of cavities are transported from the first end to the second end.

In some aspects, the techniques described herein relate to a system, wherein the user interface is further configured to allow the user of the system to at least move the roller closer to or farther from the transport path and/or between the first end and the second end.

In some aspects, the techniques described herein relate to a system, wherein each cavity of the plurality of cavities include a thru-hole.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a side view of a laser-etching system according to aspects of the present disclosure.

FIG. 2 is a perspective view of a conveyor system according to aspects of the present disclosure.

FIG. 3A is a top view of a carrier bar according to aspects of the present disclosure.

FIG. 3B is a side view of a carrier bar according to FIG. 3A.

FIG. 4A is a top view of a carrier bar according to aspects of the present disclosure.

FIG. 4B is a top view of a carrier bar according to aspects of the present disclosure.

FIG. 4C is a top view of a carrier bar according to aspects of the present disclosure.

FIG. 5 illustrates an implementation of a computer system that executes techniques of a laser-etching system according to aspects of the present disclosure.

FIG. 6 shows an exemplary flowchart according to aspects of the present disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value.

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them. As used in the present disclosure, the singular forms “a,” “an” and “the” include plural referents unless the context clearly dictates otherwise.

References to “embodiment,” “an embodiment,” “one embodiment,” “in various embodiments,” “certain embodiments,” “some embodiments,” “other embodiments,” “certain other embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

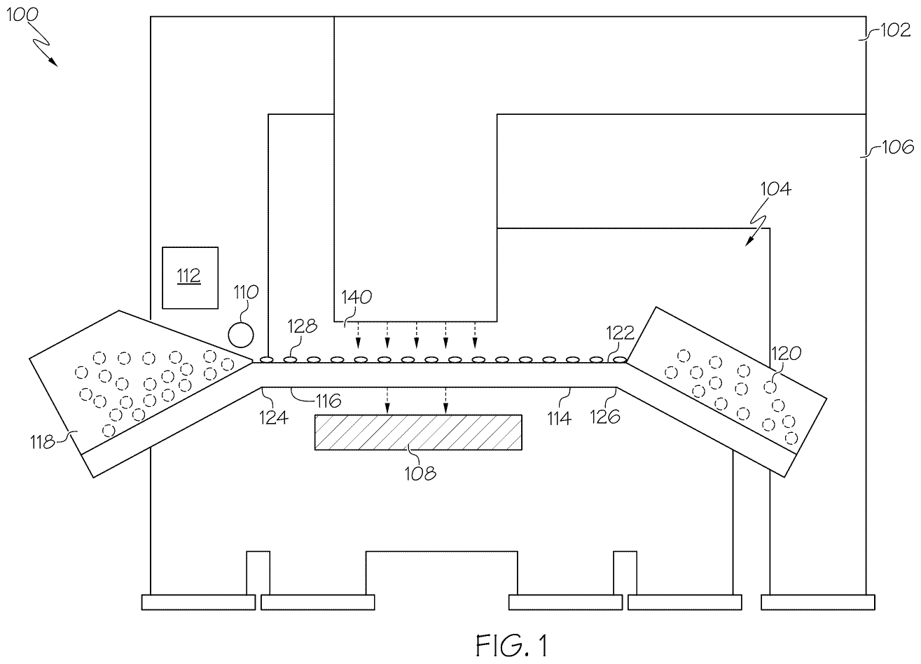

FIG. 1 is a side view of a laser-etching system according to aspects of the present disclosure. Laser-etching system 100 may include a laser system 102, a conveyor system 104, support structure 106, a laser absorption plate 108 (e.g., a laser heat sink), a brush 110, and a UI. Conveyor system 104, as will be further described below, may be designed to efficiently provide product to laser system 102. Due to conveyor system 104, laser-etching system 100 may have a high production rate without having a large physical footprint. Support structure 106 may ensure each component of laser-etching system 100 is structurally sound and adequately protect from the external environment. Support structure 106 may be made of any suitable material capable of providing laser-etching system 100 with a durable, strong structure such as any combination of steel, aluminum alloy, cast iron, titanium, etc.

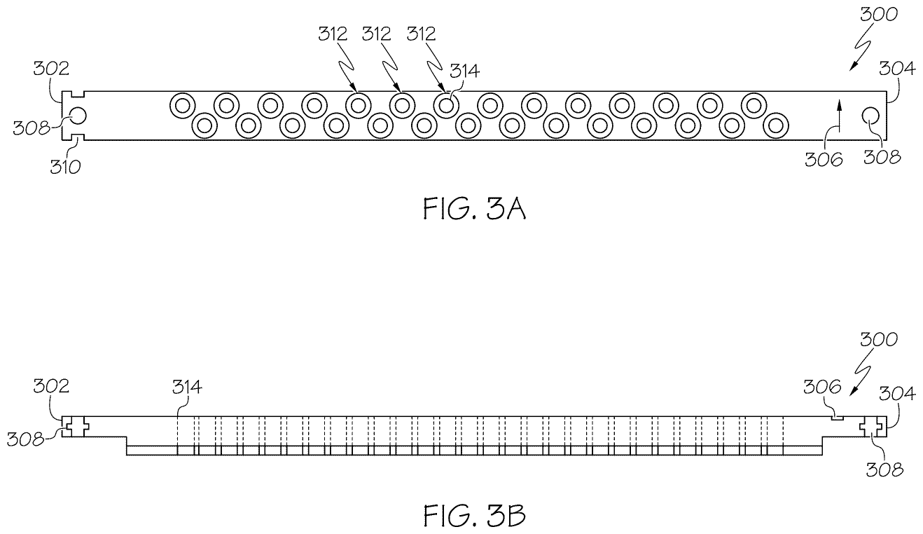

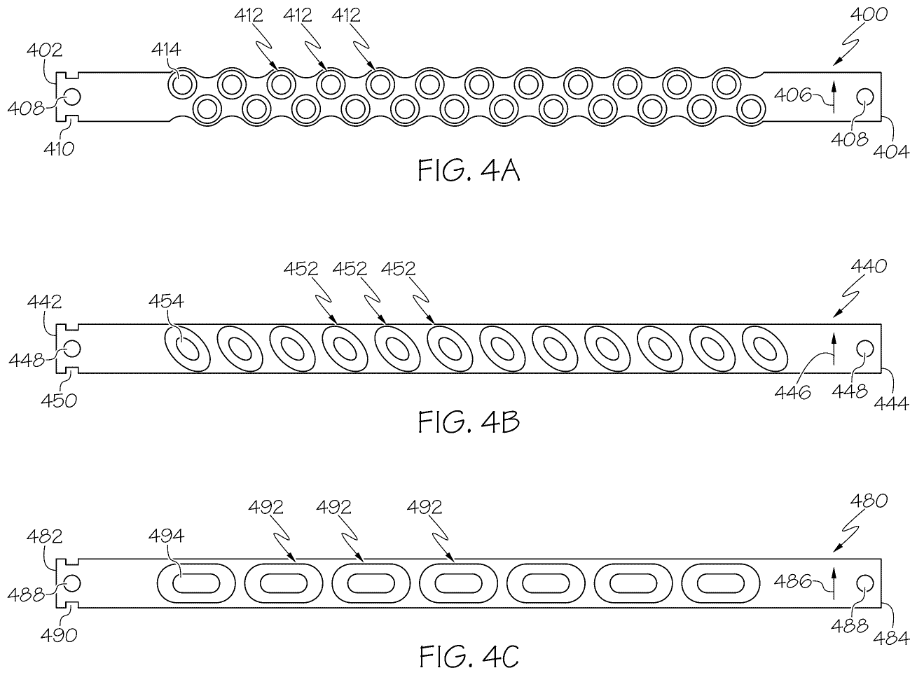

Conveyor system 104 may further include carrier bars 116 and a transport path 122 between an inlet 118 and an outlet 120 with a first end 124 adjacent to inlet 118 and a second end 134 adjacent to outlet 120. Conveyor system 104 may be configured to transport a plurality of product 128 from inlet 118 to outlet 120 via transport path 122. As described herein, plurality of product 128 may be any type of product suitable for laser-etching. Preferably, plurality of product 128 is edible product (e.g., confectionary product) produced for consumers. For example, plurality of product 128 may be a chocolate product, a sweet product, a sugary product, etc. Plurality of product 128 may also be any shape or size. In an aspect, plurality of product 128 is small and has a substantially circular cross-section. In another aspect, plurality of product 128 is large and has a substantially oval cross-section. In yet another aspect, plurality of product 128 is both small and large with several cross-sections including rectangular, circular, and other non-uniform geometric shapes. The design of carrier bars 116, as will be seen with respect to FIGS. 3A-4C, may change to accommodate the specific geometry of the product being conveyed.

Conveyor system 104 may be powered by any way known in the art. For example, conveyor system 104 may be powered by one or more electric motors, hydraulic motors, and/or pneumatic motors. User interface 112 may allow a user of the laser-etching system 100 (or simply the conveyor system 104) to control conveyor system 104 and/or other components of laser-etching system 100 as described below.

Conveyor system 104 may facilitate the transportation process of the plurality of product 128. Conveyor system 104 may rotate about a first axis (e.g., the axis that is normal to the page in FIG. 1) in a transporting direction. For example, with respect to FIG. 1, conveyor system 104 may rotate clockwise about the first axis such that objects (e.g., product) are conveyed (e.g., transported) from left (e.g., inlet 118) to right (e.g., outlet 120). In this way, conveyor system 104 facilitates the movement of plurality of product 128 on transport path 122 from first end 124 to second end 126. In an aspect, conveyor system 104 is one conveyor system that goes around inlet 118, transport path 122, and outlet 120. In another aspect, conveyor system 104 is three separate conveyor systems, one of which goes around inlet 118, one of which goes around transport path 122, and one of which goes around outlet 120. Further, a conveyor system may not be supplied to outlet 120 and, instead, outlet 120 may be angled such that plurality of product 128 fall into outlet 120 due to gravity. In an embodiment, outlet 120 includes a conveyor system and is angled. Conveyor system 104 may be made up of carrier bars 116 such that the plurality of product 128 contact and are transported on carrier bars 116.

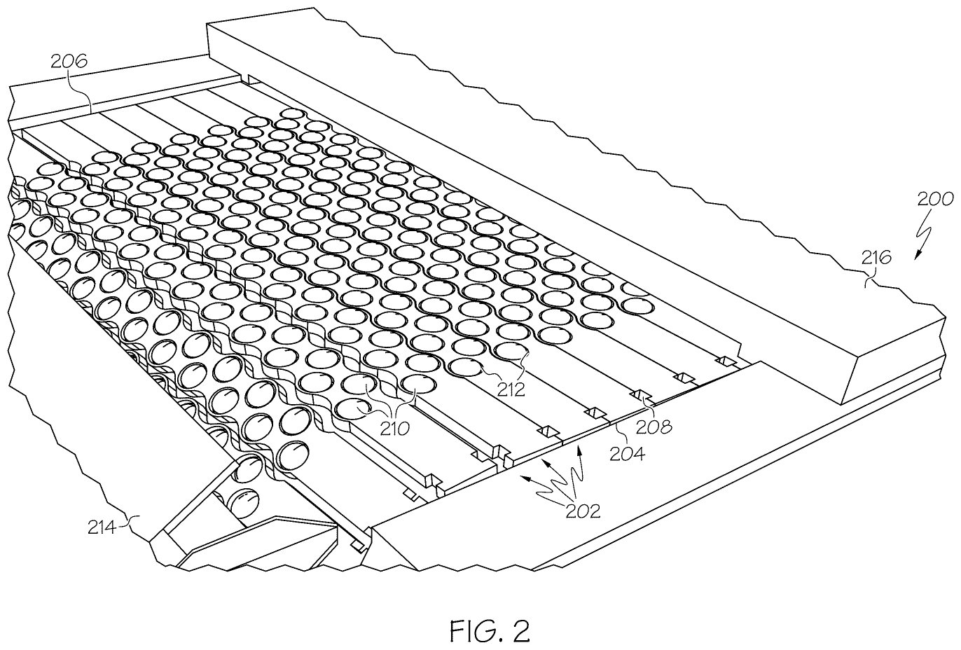

Specifically, carrier bars 116 may attach to conveyor system 104 via a “snap-in pin” system. Carrier bars 116 may be secured to conveyor system 104 in any way known in the art such as clamps, clips, adhesive, magnets, hooks, straps, bolts, screws, etc. In some aspects, carrier bars 116 may be provided over a conveyor belt 114 of conveyor system 104. This may allow for the same machine to be customized. For example, in some applications a machine may need conveyor belt 114 while in other applications the same machine may need carrier bars 116. Carrier bars 116 are designed to be easily added to and/or removed from a system. Carrier bars 116 may assist in organizing plurality of product 128 for proper transportation through laser-etching system 100, as will be further seen and described with respect to FIG. 2. Since laser system 102 interacts with plurality of product 128, plurality of product 128 may be preferably provided to laser system 102 in a way that the laser beams of laser system 102 can quickly and properly laser-etch an outer surface of plurality of product 128.

For example, if plurality of product 128 were transported on transport path 122 in a pile, with some product entirely covering and/or substantially overlapping others, laser system 102 would be unable to laser-etch each product. It would be time-consuming and inefficient to sort out a large amount of product that was notlaser-etched to then supply them to laser system 102 once again. Thus, carrier bars 116 provide an efficient way to organize the plurality of product 128 for laser system 102 to enable a high production rate for laser-etching system 100.

In the embodiments where conveyor system 104 is split into three separate conveyor systems, carrier bars 116 may be provided only for the conveyor system that goes around transport path 122. Additionally, carrier bars 116 may be provided for the conveyor system that goes around inlet 118 and/or outlet 120. Thus, a laser-etching system may utilize a combination of conveyor belt 114 and carrier bars 116

Laser system 102 may provide laser beams directly above a transport path 122 of conveyor system 104 (e.g., a path that product is conveyed/transported by the conveyor system to the laser system) to laser-etch outer surfaces of a plurality of product 128 (e.g., objects). At least some of the components of laser system 102 may be housed in a large box supported by support structure 106 above conveyor system 104. Specifically, laser system 102 may include one or more laser sources, one or more beam splitters, and one or more beam deflectors. The one or more laser sources of laser system 102 may emit one or more laser beams. These laser beams are configured to ablate the outer surface of the product supplied to laser-etching system 100. The laser beams are split into a plurality of beam segments via the one or more beam splitters. The one or more beam splitters may be any device known in the art such as plate beam splitters, cube beam splitters, polarizing beam splitters, dichroic beam splitters, or any combination thereof. Preferably, the one or more beam splitters of laser system 102 split the laser beams into beam segments of the same (or nearly the same) strength. The plurality of beam segments may be directed to individual cavities of the carrier bars 116 via one or more beam deflectors (e.g., galvanometers) to laser-etch the product within each cavity on transport path 122.

Inlet 118 may be adjacent to first end 124 such that inlet 118 supplies the plurality of product 128 to the transport path 122 for laser-etching via laser system 102. Inlet 118 may be a hopper or may be configured to receive the product 128 from a hopper device. Inlet 118 may have side walls and a back wall to create a housing with an open top. Inlet 118 may be angled such that the end of inlet 118 that is adjacent to transport path 122 is higher than the opposite end (as seen in FIG. 1).

Because of the angle of inlet 118, the plurality of product 128 do not enter the transport path 122 unless the conveyor system 104 is configured to transport product. Product 128 may also naturally fall back into inlet 118 if the product 128 is not properly positioned on carrier bars 116. The walls of inlet 118 may be tall enough that a large amount of product can stay within inlet 118 and not overflow.

Outlet 120 may be adjacent to second end 126 such that outlet 120 groups the plurality of product 128 after being laser-etched by laser system 102. Outlet 120 may collect and store the finished product (e.g., product 128 that has been laser-etched) or may provide the finished product to a collection device/system. Outlet 120 may be angled such that plurality of product 128 fall from transport path 122 into outlet 120 (e.g., the side of outlet 120 adjacent to transport path 122 may be higher than the opposite side so gravity causes the plurality of product 128 to move within and/or through outlet 120. Outlet 120 may have a first end adjacent to transport path 122 and a second end opposite to the first end. Both the first end and the second end may have openings configured to allow plurality of product 128 through. Outlet 120 may have walls between first end and second end. Outlet 120 may be completed surrounded by sidewalls with openings on opposite ends. Alternatively, the second end of outlet 120 (e.g., the end farthest from second end 126) may instead be a wall/without an opening.

It will be appreciated that, while laser-etching system 100 describes transporting the product 128 for laser-etching, the conveyor system 104 (and specifically carrier bars 116) may be used in systems without laser-etching components. Conveyor system 104 and carrier bars 116 are further described below in systems with or without laser-etching components. Thus, the laser-etching components described with respect to laser-etching system 100 are simply illustrative of an embodiment of the conveyor system 104. For example, the carrier bars 116 may be used in different conveying systems, such as conveying systems for branding, manufacturing, bottling, processing, etc.

FIG. 2 is a perspective view of a conveyor system according to aspects of the present disclosure. Conveyor system 200 may be part of a laser-etching system, such as laser-etching system 100. Conveyor system 200 may convey product from one end to another. Similar to the conveyor system 104 of laser-etching system 100, conveyor system 200 may transport product on a transport path and to an outlet 214.

As seen in FIG. 2, conveyor system 200 may have a conveyor system (not shown) entirely surrounded by carrier bars 202. A portion of conveyor system 200 (e.g., the portion in which the laser system etches the product) may be covered by a cover 216. Carrier bars 202 may include a first side 204, a second side 206, a timing sensor 208, and a plurality of cavities 212 that a plurality of product 210 fit within. Carrier bars 202 may be made of any suitable material. For example, carrier bars 202 may be made of a durable, hard material such as steel. As will be described below, carrier bars 202 provides the product to the laser system in a uniform way so the laser system is then able to efficiently and accurately laser-etch an outer surface of the product.

Plurality of cavities 212 may be configured to hold individual product of the plurality of product 210. The plurality of cavities 212 may be deep such that the plurality of product 210 are entirely within the cavities (e.g., the tops of the plurality of product 210 are at or below the surface of carrier bars 202). Alternatively, the plurality of cavities 212 may be shallow such that the plurality of product 210 are only partially within the cavities (e.g., the tops of the plurality of product 210 are above the surface of carrier bars 202). Each carrier bar 202 may have multiple rows of cavities 212. Each carrier bar 202 may only have one row of cavities 212. The cavities 212 may be equally spaced apart.

The perimeter of cavities 212 may be slightly larger than the perimeter of product 210 such that product 210 fits within cavities 212 but cannot substantially shift in position. The plurality of cavities 212 may only be provided near the center point of the carrier bars 202 between first side 204 and second side 206. That is, carrier bars 202 may have a solid portion near first side 204 and second side 206 without any cavities 212. However, cavities 212 may be provided along the entire length of carrier bars 202. The configuration of the laser system of a laser-etching system may impact where the cavities 212 are located on carrier bars 202 (e.g., the cavities will be provided on the carrier bars in such a way that the laser(s) of laser system can laser-etch the product within the cavities). Cavities 212 may include thru-holes (seen in FIGS. 2A-4C) to allow a laser beam segment to pass through and not damage the carrier bars 202.

Each cavity of the cavities 212 may be substantially solid with a small opening (e.g., a thru-hole) centered at the center-point of the respective cavity. In use, there may be cavities that do not include a product. For example, a system may run out of product halfway through a cycle, product may fall out of a cavity, or product may have simply missed certain cavities. In any case, the opening in each cavity of the cavities 212 allow for the laser beam segment, when laser-etching, to pass through the carrier bars 202 without damaging (e.g., burning, melting, etc.) the carrier bars 202.

A laser absorption plate (e.g., a laser heat sink) may be provided below the transport path of the conveyor system where the laser system laser-etches the product (as seen in FIG. 1 with laser absorption plate 108). Thus, if a laser beam segment fires into a cavity without product, the laser beam segment passes straight through the cavity and hits the laser absorption plate instead of any other part of the system. Since the laser absorption plate is designed to absorb lasers, no damage will be done to the system. The laser absorption plate may be made of any suitable material capable of absorbing the laser beam segments generated by a laser system such as metals with a high thermal conductivity (e.g., aluminum, copper, gold, etc.), ceramics, or composites. Alternatively, the laser heat sink may be part of the carrier bars 116. For example, the cavities may not have a thru-hole but, instead, the bottom portion of each cavity is coated and/or is a different material, suitable for laser absorption, than the rest of the carrier bar. A device (such as brush 110 seen in FIG. 1) positioned at the beginning of the transport path may assist in ensuring the plurality of product 128 find respective cavities 212 to fit within prior to being laser-etched to reduce the chance of a misfired laser beam segment. Brush 110 (e.g., a moving apparatus) may be positioned at the interface of the inlet 118 and the transport path. That is, the brush 110 may be substantially near the end of the inlet 118 closest to the transport path.

Specifically, brush 110 may be placed at a certain distance above carrier bars 116 or 212 at a location prior to laser system 102 such that brush 110 physically contacts only the product that are on top of other product and/or product that are not within respective cavities (e.g., product outside of the cavities). In this way, brush 110 may move product into empty cavities. Preferably, brush 110 is located at the beginning of the transport path (e.g., first end 124) so that product that contacts brush 110 may return to an inlet (e.g., inlet 118) and/or be brushed into open cavities on transport path 122. Brush 110 may not be a brush but simply any apparatus configured to help place plurality of product 128 within the plurality of cavities (e.g., paddles, air blowers, vacuums, rollers, mechanical grippers, etc.). The laser-system used may allow for tolerances for product placement within the cavities.

For example, even when using a device such as brush 110, some of plurality of product 210 may still be improperly sent to the laser system. Some product may be offset in respective cavities, where the product is almost entirely against one half of the cavity and is substantially sideways. Additionally, some product may partially stack on other product. Product may be stuck between two cavities when provided to the laser system. In either situation, the laser system may be able to still laser-etch the incorrectly provided product.

On one end of each carrier bar (e.g., near first side 204 in FIG. 2), a timing sensor 208 may be provided. Since a laser system may need to physically scan the carrier bars to appropriately time the laser beams, timing sensor 208 may be in the form of a cutout (as seen in FIG. 2). The geometry of the carrier bars are programmed into the laser system so the laser system can accurately fire lasers into the cavities based on the position of the cutout 208. Specifically, the laser system may be aware of the distance from the timing sensor 208 to the first cavity, the spacing of each cavity, the geometry of each cavity, and the distance from the first cavity to the last cavity. In other words, the laser system is programmed with all of the necessary information to accurately laser-etch product provided by carrier bars 202. Timing sensor 208 may be any suitable method for timing (e.g., calibrating) a laser system, such as an optical interrupter (e.g., an emitter and corresponding receiver) embedded in carrier bars 202, a photodiode array surrounding the cavities to provide a perimeter for the laser, etc.

As will be discussed with respect to FIGS. 3A-4C, the carrier bars may be designed differently depending on the specifics (e.g., product size, product geometry, production rate, system size, etc.) of a laser-etching system. Because carrier bars 202 can easily fit any conventional conveyor system, carrier bars 202 may be used by various systems. It is contemplated carrier bars 202 may be used for non-laser-etching systems as carrier bars 202 can be useful for any system that desires uniform organization for steps in production of product.

FIG. 3A is a top view of a carrier bar according to aspects of the present disclosure. FIG. 3B is a side view of a carrier bar according to FIG. 3A. Carrier bar 300 may have a first side 302, a second side 304, an engraving 306, a hole 308 on each end (e.g., sides 302 and 304), timing sensor 310, and cavities 312, each of which include an opening 314. Carrier bar 300 may have a substantially rectangular top face (e.g., the surface that is seen in use and faces the laser system) besides the cutout for timing sensor 310. Carrier bar 300 may be a different shape as seen in FIG. 4A. It is preferred each carrier bar 300 is shaped the same way so they can fit next to one another properly and without unintended gaps. Timing sensor 310, as described with respect to timing sensor 208, may be near first side 302 and assist in calibrating the laser system.

Engraving 306 may provide a textual or visual descriptor to assist a user in properly inserting (e.g., coupling) the carrier bar 300 to a conveyor system. As an example shown in FIG. 3A, engraving 306 may be an arrow pointing a direction indicative of the way the carrier bar 300 should be facing. That is, when there are multiple carrier bars 300 next to one another, the arrow 306 on each carrier bar 300 should face the same direction. Engraving 306 may instead be a word such as “LEFT”, “RIGHT”, “FRONT”, or “BACK”. Engraving 306 may be any combination of text and images to convey to a user how to prove the carrier bar 300. Additionally engraving 306 may be, instead of an engraving, an embossment, an ink, or any other way to show the message.

Holes 308 may be substantially near the first side 302 and the second side 304. Holes 308 may be a pin hole configured to receive a pin from the conveyor system to couple the carrier bar 300 to a conveyor system that utilizes a pin connection. Holes 308 may be different structures depending on the type of coupling for the specific conveyor system. For example, holes 308 may be a clamp that connects to a loop on the conveyor system. Holes 308 may be positioned away from cavities 312 as cavities 312 are centered in the middle of carrier bar 300 between first side 302 and second side 304.

Cavities 312 include an opening 314 in the middle of each cavity. Cavities 312 may be mostly solid so the product does not slip or get stuck inside the opening 314. Opening 314, however, may be large enough that laser beam, when no product is present in a cavity, passes straight through and does not contact the carrier bar 300. Opening 314, as previously described, allows for the laser beam to pass through carrier bar 300 and onto a laser heat sink. Thus, carrier bar 300 and the conveyor system is protected from damage from the laser system.

FIGS. 4A-4C are top views of different carrier bars according to aspects of the present disclosure. The components of each of carrier bar 400, 440, and 480 may have similar functions as described above for carrier bar 300. With respect to 4A, carrier bar 400 may have a first side 402, a second side 404, an engraving 406, a hole 408 on each end (e.g., sides 402 and 404), timing sensor 410, and cavities 412, each of which include an opening 414. Unlike carrier bar 300, carrier bar 440, and carrier bar 480, carrier bar 400 may not be substantially rectangular. As seen, the top face of carrier bar 400 may be shaped by the cavities 412 included. Thus, carrier bar 400 may have straight ends at first side 402 and second side 404 but the sides between first side 402 and second side 404 may include curved portions (e.g., “wavy”) because the cavities 412 are circular and a portion of the circle defines a part of the side of carrier bar 400 (e.g., the cavities 412 partially protrude past the edge). Carrier bar 400 may be curved between (and before the end cavities) each cavity 412 as well. It will be appreciated that multiple carrier bars 400 can still be placed directly against one another (e.g., they abut each other) without introducing unintended gaps between the carrier bars as the bump (e.g., protrusion) made by a cavity of one carrier bar is received by an indentation of another carrier bar.

With respect to 4B, carrier bar 440 may have a first side 442, a second side 444, an engraving 446, a hole 448 on each end (e.g., sides 442 and 444), timing sensor 450, and cavities 452, each of which include an opening 454. As seen, cavities 452 may not be circular but instead oval. As explained previously and illustrated with FIGS. 4B and 4C the cavities on a carrier bar may be any shape desired for the specific implementation. Thus, for product that may be oval-shaped instead of circular, cavities 452 may be preferred and used instead.

With respect to 4C, carrier bar 480 may have a first side 482, a second side 484, an engraving 486, a hole 488 on each end (e.g., sides 482 and 484), timing sensor 490, and cavities 492, each of which include an opening 494. As seen, cavities 492 may not be circular but instead stadium shaped. That is, cavities 492 may have two opposite straight sides and two opposite curved sides. Once again, cavities 492 may be any shape necessary to fit product within.

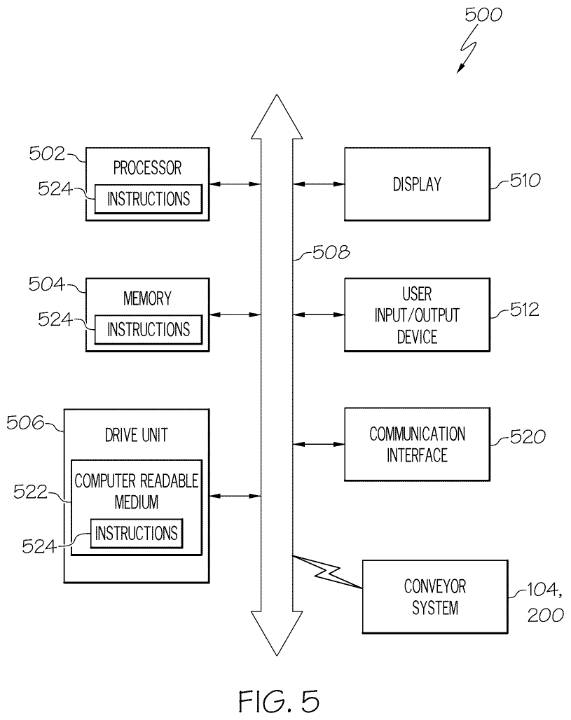

FIG. 5 illustrates an implementation of a computer system that executes techniques of a laser-etching system according to aspects of the present disclosure. For example, user interface 112 may be the computer system 500. User interface 112 may include less components than shown in FIG. 5. As such, the components illustrated in computer system 500 are not meant to be limiting and/or required in the present disclosure as it will be appreciated by a person in the art. Additionally, while computer system 500 is illustrated as the computer system for conveyor system 104, conveyor system 104 may have a separate computer system in communication with computer system 500. In this way, computer system 500 may remotely connect to laser-etching system 100, allowing a user to remotely control the conveyor system 104.

The computer system 500 may include a set of instructions that are executed to cause the laser-etching system 100 to perform certain functions. For example, computer system 500 may include instructions directed to conveyor system 104 (or conveyor system 200). In an example, computer system 500 is directly interacted with by a user to program the different components of laser-etching system 100. In an example, computer system 500 is preprogrammed and uploads the programs for the different components of laser-etching system 100 to run.

As illustrated in FIG. 5, the computer system 500 includes a processor 502, e.g., a central processing unit (CPU), a graphics processing unit (GPU), or both. The processor 502 is a component in a variety of systems. For example, the processor 502 is part of the conveyor system 104. The processor 502 is one or more processors, digital signal processors, application specific integrated circuits, field programmable gate arrays, servers, networks, digital circuits, analog circuits, combinations thereof, or other now known or later developed devices for analyzing and processing data. The processor 502 implements a program, such as code generated manually (e.g., programmed).

The computer system 500 includes a memory 504 that communicates via bus 508. Memory 504 is a main memory, a static memory, or a dynamic memory. Memory 504 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. Memory 504 is an external storage device or database for storing data. Examples include a hard drive, flash drive, compact disc (CD), digital video disc (DVD), memory card, memory stick, floppy disc, universal serial bus (USB) memory device, or any other device operative to store data. The memory 504 is operable to store instructions executable by the processor 502. The functions, acts, or tasks illustrated in the figures or described herein are performed by processor 502 executing the instructions stored in memory 504. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 500 further includes a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 acts as an interface for the user to see the functioning of the processor 502, or specifically as an interface with the software stored in the memory 504 or in the drive unit 506.

Additionally or alternatively, the computer system 500 includes an input/output device 512 configured to allow a user to interact with any of the components of the computer system 500. The input/output device 512 is a number pad, a keyboard, a cursor control device, such as a mouse, a joystick, touch screen display, remote control, or any other device operative to interact with the computer system 500.

The computer system 500 also includes the drive unit 506 implemented as a disk or optical drive. The drive unit 506 includes a computer-readable medium 522 in which one or more sets of instructions 524, e.g. software, is embedded. Further, the sets of instructions 524 embodies one or more of the methods or logic as described herein. Instructions 524 resides completely or partially within memory 504 and/or within processor 502 during execution by the computer system 500. The memory 504 and the processor 502 also include computer-readable media as discussed above.

In some systems, computer-readable medium 522 includes the set of instructions 524 or receives and executes the set of instructions 524 responsive to a propagated signal so that conveyor system 104 communicates data to computer system 500. Further, the sets of instructions 524 are transmitted or received via the communication port or interface 520, and/or using the bus 508. The communication port or interface 520 is a part of the processor 502 or is a separate component. The communication port or interface 520 is created in software or is a physical connection in hardware. The communication port or interface 520 is configured to connect with the conveyor system 104, display 510, or any other components in the computer system 500, or combinations thereof.

While the computer-readable medium 522 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 522 is non-transitory, and may be tangible.

The computer-readable medium 522 includes a solid-state memory such as a memory card or other package that houses one or more non-volatile read-only memories. The computer-readable medium 522 is a random-access memory or other volatile re-writable memory. Additionally or alternatively, the computer-readable medium 522 includes a magneto-optical or optical medium, such as a disk or tapes or other storage device to capture carrier wave signals such as a signal communicated over a transmission medium.

In an alternative implementation, dedicated hardware implementations, such as application specific integrated circuits (ASICs), programmable logic arrays, and other hardware devices, is constructed to implement one or more of the methods described herein. For example, conveyor system 104 may include a separate ASIC, or may include an ASIC instead of any software or in place of certain aspects of software. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Regardless of implementation (e.g., whether implemented via an ASIC, computer system 500, etc.), conveyor system 104 includes numerous programmable controls. For example, user interface 112 may turn conveyor system 104 on/off, control the speed of conveyor system 104, control the angle of incline of inlet 118, move brush 110 (e.g., move brush 110 closer to or farther from the transport path 122 and/or between the first end 124 and the second end 134) release carrier bars 116, etc. All of the described functions may be controlled by a singular user interface 112, such as computer system 500, an ASIC, or any combination of software, firmware, and hardware.

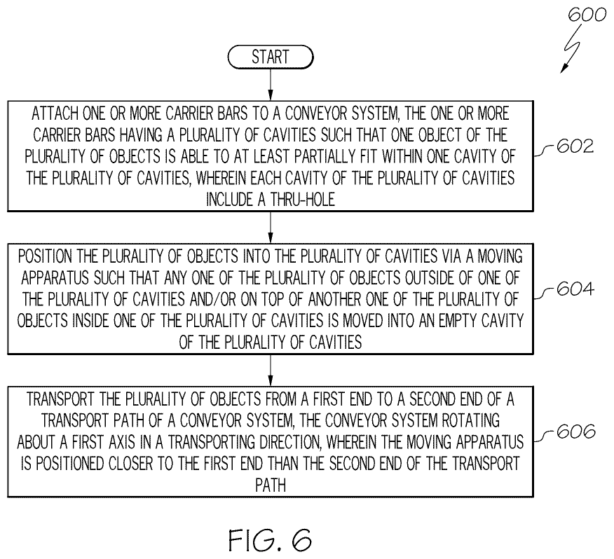

FIG. 6 is a flow chart 600 according to aspects of the present disclosure. Flow chart 600 may correspond to a method of laser-etching a plurality of objects. The method described by flow chart 600 may use components that have been previously described with respect to laser-etching system 100. Accordingly, the disclosure below uses the same reference labels as laser-etching system 100 when describing the various steps of flow chart 600, but flow chart 600 is not limited by the explicit components described in laser-etching system 100.

Step 602 may include attaching one or more carrier bars 116 to a conveyor system 104, the one or more carrier bars 116 having a plurality of cavities 212 such that one object (e.g., piece of product 128) may be able to at least partially fit within a cavity 212. Each cavity 212 may include a thru-hole 314. Each cavity 212 may include a timing sensor 450 to calibrate the plurality of beam segments.

Step 604 may include positioning the plurality of objects 128 into the plurality of cavities 212 via a moving apparatus (e.g., brush 110) such that any of the plurality of objects 128 outside of one of the plurality of cavities 212 and/or on top of another one of the plurality of objects 128 inside one of the plurality of cavities 212 may be moved into an empty cavity of the plurality of cavities 212. The moving apparatus may be a brush or a roller.

Step 606 may include transporting the plurality of objects 128 from a first end 124 to a second end 126 of a transport path 122 of a conveyor system 104. The conveyor system 104 may rotate about a first axis in a transporting direction and the moving apparatus 110 may be positioned closer to the first end 124 than the second end 126 of the transport path 122.

The method may also include laser-etching the plurality of objects 128 via a laser system 102 between the first end 124 and second end 126 of the transport path 122. The laser system 102 may produce a plurality of beam segments and each beam segment may be directed onto an outer surface of an object 128 such that each beam segment laser-etches the outer surface of an object 128. The plurality of beam segments may be directed through the thru-holes 314 onto a laser absorption plate 108 for any of the plurality of cavities 212 that are empty. The method may include controlling, via a user interface 112, the conveyor system 104. The user interface 112 may allow a user to control turning the conveyor system 104 on, turning the conveyor system 104 off, or releasing the one or more carrier bars 116.

It will be apparent to those skilled in the art that modifications may be made in the disclosed systems and methods without departing from the scope of the disclosure. Other aspects of the disclosure will be apparent to those skilled in the art from consideration of the specification and practice of the features disclosed herein. It is intended that the specification and embodiments be considered as exemplary only.

What is claimed is:

1. A system for transporting a plurality of objects, the system comprising:
a conveyor system with a transport path that transports the plurality of objects from a first end to a second end, the conveyor system rotating about a first axis in a transporting direction;
one or more carrier bars attached to the conveyor system, the one or more carrier bars having a plurality of cavities such that one object of the plurality of objects is able to at least partially fit within one cavity of the plurality of cavities, wherein each cavity of the plurality of cavities include a thru-hole, and wherein each carrier bar of the one or more carrier bars include a timing sensor; and
a laser system configured to interact with the plurality of objects while the plurality of objects are within the plurality of cavities on the transport path between the first end and the second end, wherein the laser system produces a plurality of beam segments, wherein each beam segment is configured to laser-etch an outer surface of an object of the plurality of objects, and wherein the timing sensor calibrates the plurality of beam segments.

2. The system of claim 1, the system further comprising:
a moving apparatus configured to move any one of the plurality of objects outside of one of the plurality of cavities and/or on top of another one of the plurality of objects inside one of the plurality of cavities on the transport path such that only objects within the plurality of cavities are transported to the laser system.

3. The system of claim 2, the system further comprising:
a user interface configured to allow a user of the system to at least turn the laser system on, turn the laser system off, turn the conveyor system on, turn the conveyor system off, release the one or more carrier bars, and/or move the moving apparatus closer to or farther from the transport path and/or between the first end and the second end.

4. The system of claim 1, the system further comprising:
a laser absorption plate, wherein the plurality of beam segments are directed through the thru-holes onto the laser absorption plate for any of the plurality of cavities that are empty.

5. The system of claim 1, wherein, for each carrier bar of the one or more carrier bars, the timing sensor is a cutout closer to a first end of the carrier bar than a second end of the carrier bar.

6. The system of claim 5, wherein a first side and a second side of the carrier bar between the first end and the second end are shaped by at least a portion of a perimeter of the plurality of cavities.

7. The system of claim 1, wherein the one or more carrier bars are connected to the conveyor system via a pin connection.

8. A method for transporting a plurality of objects, the method comprising:
attaching one or more carrier bars to a conveyor system, the one or more carrier bars having a plurality of cavities such that one object of the plurality of objects is able to at least partially fit within one cavity of the plurality of cavities, wherein each cavity of the plurality of cavities include a thru-hole;
positioning the plurality of objects into the plurality of cavities via a moving apparatus such that any one of the plurality of objects outside of one of the plurality of cavities and/or on top of another one of the plurality of objects inside one of the plurality of cavities is moved into an empty cavity of the plurality of cavities; and
transporting the plurality of objects from a first end to a second end of a transport path of a conveyor system, the conveyor system rotating about a first axis in a transporting direction, wherein the moving apparatus is positioned closer to the first end than the second end of the transport path.

9. The method of claim 8, wherein the moving apparatus is a brush or a roller.

10. The method of claim 8, the method further comprising:
laser-etching the plurality of objects via a laser system between the first end and second end of the transport path, wherein the laser system produces a plurality of beam segments, and wherein each beam segment of the plurality of beam segments is directed onto an outer surface of an object of the plurality of objects such that each beam segment laser-etches the outer surface of the object.

11. The method of claim 10, wherein each cavity of the plurality of cavities include a timing sensor to calibrate the plurality of beam segments.

12. The method of claim 8, the method further comprising:
controlling, via a user interface, the conveyor system, wherein controlling the conveyor system includes at least one of turning the conveyor system on, turning the conveyor system off, or releasing the one or more carrier bars.

13. The method of claim 10, wherein the plurality of beam segments are directed through the thru-holes onto a laser absorption plate for any of the plurality of cavities that are empty.

14. A system for transporting a plurality of objects, the system comprising:
a conveyor system with a transport path that transports the plurality of objects from a first end to a second end, the conveyor system rotating about a first axis in a transporting direction;
one or more carrier bars attached to the conveyor system, the one or more carrier bars having a plurality of cavities such that one object of the plurality of objects is able to at least partially fit within one cavity of the plurality of cavities; and
a user interface configured to allow a user of the system to at least turn the conveyor system on, turn the conveyor system off and/or release the one or more carrier bars.

15. The system of claim 14, the system further comprising:
an inlet adjacent to the first end, the inlet grouping the plurality of objects for transportation on the conveyor system via the transport path.

16. The system of claim 15, wherein the plurality of cavities are substantially circular.

17. The system of claim 14, wherein the plurality of cavities are equally spaced apart.

18. The system of claim 14, the system further comprising:
a roller configured to move any one of the plurality of objects outside of one of the plurality of cavities and/or on top of another one of the plurality of objects inside one of the plurality of cavities on the transport path such that only objects within the plurality of cavities are transported from the first end to the second end.

19. The system of claim 18, wherein the user interface is further configured to allow the user of the system to at least move the roller closer to or farther from the transport path and/or between the first end and the second end.

20. The system of claim 14, wherein each cavity of the plurality of cavities include a thru-hole.
